(19) United States
(12) Patent Application Publication
(10) Pub. No.: US 2016/0025259 A1
(43) Pub. Date: Jan. 28, 2016

(54) ADJUSTABLE KINEMATIC MOUNT

(71) Applicant: Sandia Corporation, Albuquerque, NM (US)

(72) Inventors: Aaron M. Ison, Albuquerque, NM (US); Edward G. Winrow, Albuquerque, NM (US)

(73) Assignee: Sandia Corporation, Albuquerque, NM (US)

(21) Appl. No.: 13/830,392

(22) Filed: Mar. 14, 2013

Related U.S. Application Data
(60) Provisional application No. 61/691,164, filed on Aug. 20, 2012.

(51) Int. Cl. F16M 11/18

(52) U.S. Cl. CPC F16M 11/18

(57) ABSTRACT

The various technologies presented herein relate to positioning one or more devices of an optical apparatus. In a general embodiment, a tube having a threaded external surface is secured to an alignment ball, the alignment ball being located on a pair of bearings. Attached to the tube is a flange comprising a threaded aperture having the same diameter and pitch as the threaded external surface of the tube. As the tube is turned rotationally about its length, the position of the flange is change on the external surface of the tube.

### RELATED APPLICATION

This application claims priority to U.S. Provisional Patent Application No. 61/691,164, filed on Aug. 20, 2012, entitled “ADJUSTABLE KINEMATIC MOUNTS”, the entirety of which is incorporated herein by reference.

### STATEMENT OF GOVERNMENTAL INTEREST

This invention was developed under contract DE-AC04-94AL85000 between Sandia Corporation and the U.S. Department of Energy. The U.S. Government has certain rights in this invention.

### BACKGROUND

Accurate positioning and alignment of devices can be a major requirement during operation of an apparatus. For example, in a system comprising optical and/or optomechanical devices (such as a beam splitter, a gas cell, a lens, a mirror, etc.), passage of electromagnetic radiation through the various devices is desirably controlled to facilitate a very high degree of accuracy in whatever experiments, measurements, etc., are being conducted with the devices.

When performing an experiment utilizing electromagnetic radiation having a narrow frequency range, precise positioning of a lens with respect to a beam of radiation may be critical to facilitate passage of the beam of radiation through the lens as opposed to a portion or all of the beam being reflected off the surface of the lens, for example, when the surface of the lens is not correctly aligned perpendicular to the path of the beam.

### SUMMARY

The following is a brief summary of subject matter that is described in greater detail herein. This summary is not intended to be limiting as to the scope of the claims.

Described herein are various technologies pertaining to a kinematic mount, which is employable to relatively precisely position devices relative to one another. The kinematic mount may be particularly well-suited for employment with relatively complex optical systems, which comprise beam-splitters, gas cells, lenses, mirrors, and other devices. An exemplary kinematic mount comprises a plurality of kinematic apparatuses, wherein each kinematic apparatus in the plurality of kinematic apparatuses can be interacted with to adjust position of a device. An exemplary kinematic apparatus includes a cylindrical alignment tube having a proximal end and a distal end, wherein an exterior of the alignment tube is threaded. The kinematic apparatus also includes a spherical alignment ball that includes a threaded aperture. A diameter of the alignment tube corresponds to a diameter of the threaded aperture of the alignment ball, such that the threaded exterior of the alignment tube at the proximal end thereof is configured to mate with the threaded aperture of the alignment ball. The distal end of the alignment tube can include, for instance, a hexagonal head.

The kinematic mount further comprises a planar base plate, wherein the base plate includes a plurality of recesses. A number of recesses in the plurality of recesses can correspond to a number of kinematic apparatuses in the plurality of kinematic apparatuses. A respective pair of roller bearings can be positioned in each recess, wherein roller bearings in a pair of roller bearings are arranged in parallel with one another and are separated by a gap. A respective alignment ball may be positioned to rest on each pair of roller bearings.

The kinematic mount additionally includes a support structure, upon which, for example, a desirably positioned device can rest. The support structure, in an exemplary embodiment, comprises a plurality of flanges, with each flange having a threaded aperture therethrough. Positions of the threaded apertures on the support structure correspond to respective positions of the recesses of the base plate. Further, diameters of the threaded apertures of the support structure correspond to diameters of the respective alignment tubes of the kinematic apparatuses, such that threads of an alignment tube can mate with threads of a respective threaded aperture of the support structure.

In operation, when the alignment tubes of the respective kinematic apparatuses are threadedly mated with respective threaded apertures of the support structure, and the alignment balls are resting upon respective pairs of roller bearings of the base plate, the alignment apparatuses can be rotated about respective lengths thereof, thus causing position of the support structure with respect to the base plate to alter. Accordingly, height of the support structure over the base plate, as well as tilt of the support structure, can be relatively precisely configured, thereby allowing a position/tilt of a device resting upon or attached to the support structure to be relatively precisely configured.

Other aspects will be appreciated upon reading and understanding the attached figures and description.

### BRIEF DESCRIPTION OF THE DRAWINGS

FIG. 1 is a cross-sectional view of a portion of an exemplary kinematic mount.

FIG. 2 is an overhead view of the portion of the exemplary kinematic mount.

FIG. 3 is a cross-sectional view of a portion of another exemplary kinematic mount.

FIG. 4 is a perspective view of an exemplary kinematic mount that includes several kinematic apparatuses.

FIG. 5 is a photograph illustrating a portion of an exemplary kinematic mount.

FIG. 6 is a block diagram illustrating an exemplary system for controlling adjustment of a support structure.

FIG. 7 is a block diagram illustrating exemplary embodiments for accommodating thermal expansion of a device.

FIG. 8 is a flow diagram illustrating an exemplary methodology for adjusting position of a device.

FIG. 9 is a flow diagram illustrating an exemplary methodology for determining magnitude of movement.

FIG. 10 is a flow diagram illustrating an exemplary methodology for accommodating thermal expansion of a device.

FIG. 11 is a flow diagram illustrating an exemplary methodology for securing/unsecuring an aligning assembly.

FIG. 12 illustrates an exemplary computing device.

### DETAILED DESCRIPTION

Various technologies pertaining to relatively precisely positioning a device through utilization of a kinematic mount will now be described with reference to the drawings, where like reference numerals represent like elements throughout. As used herein, the term “exemplary” is intended to mean serving as an illustration or example of something, and is not intended to indicate a preference. Additionally, as used herein, the terms “approximately” and “about” are intended to encompass values within 10% of a specified value.

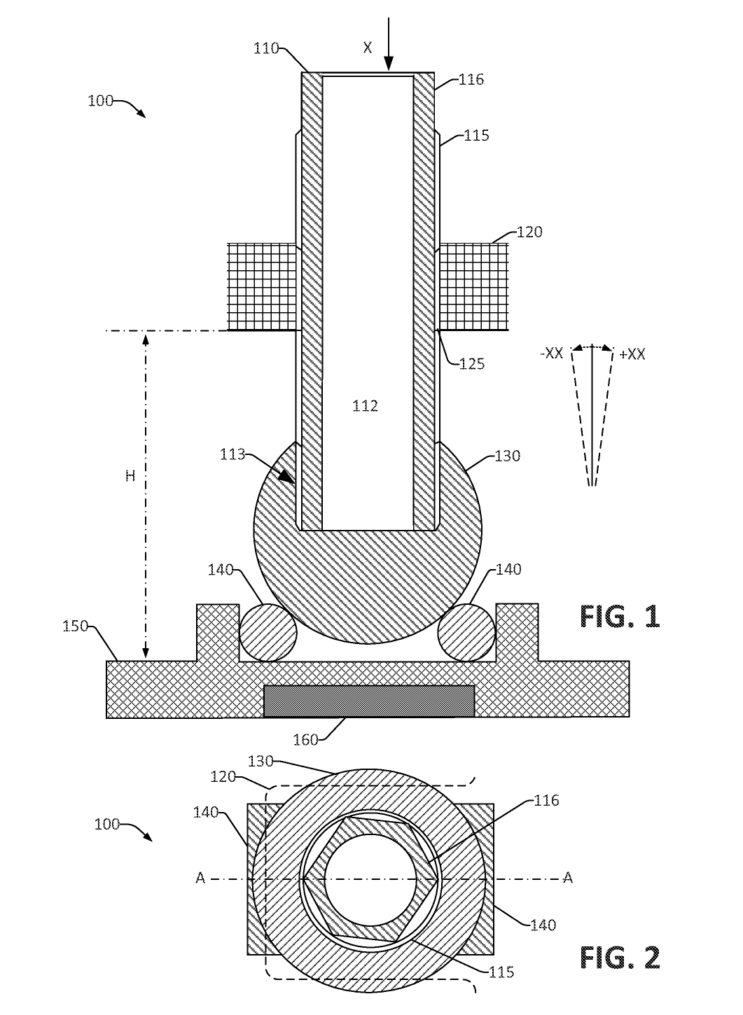

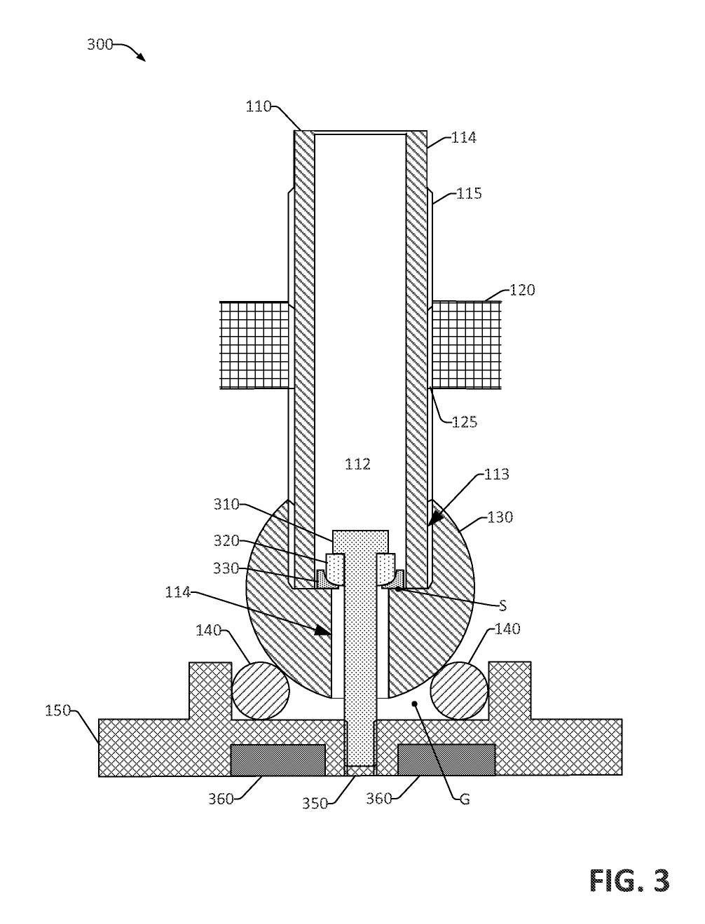

With reference now to FIG. 1, a cross-sectional view of a portion of an exemplary kinematic mount is illustrated. Such portion will be referred to herein as a kinematic assembly 100. FIG. 2 is an overhead view of the kinematic assembly 100 in an embodiment. As will be described in greater detail herein, the kinematic assembly 100 can be utilized to position a device, such as an optical device or an optomechanical device in an optical system. As can be ascertained, FIG. 1 illustrates a vertical section of the kinematic assembly 100 through A-A, and FIG. 2 illustrates an overhead view of the kinematic assembly 100 in direction X. The kinematic assembly 100 comprises two structures: 1) an aligning assembly; 2) and a support assembly. While not shown, the kinematic assembly 100 may also optionally comprise a locking assembly (shown in FIG. 3). The aligning assembly comprises an alignment tube 110, where the alignment tube 110 has a thread 115 running along its length on the exterior thereof.

The alignment assembly also includes an alignment ball 130 (which may also be referred to as an aligning ball, tooling ball, or ball) having a threaded aperture 113 extending partially therethrough. A diameter of the alignment tube 110 corresponds to a diameter of the threaded aperture 113, and pitch of threads along the exterior of the alignment tube 110 correspond to pitch of threads of the threaded aperture 113, such that the thread 115 of the alignment tube 110 mates with the threaded aperture 113, thus facilitating connection of the alignment tube 110 to the alignment ball 130. A flange 120 has a threaded aperture 125 extending therethrough, wherein a diameter of the threaded aperture 125 corresponds to the diameter of the alignment tube 110, and pitch of the thread 115 corresponds to pitch of thread in the threaded aperture 125, such that threads of the alignment tube 110 can mate with threads of the threaded aperture 125. The flange 120 can be a portion of a support structure, upon which an optical device, for instance, can rest or be attached. The support structure can be planar, such that the flange 120 is a portion of a flat plate. In other exemplary embodiments, the flange 120 can be a raised or recessed portion of the support structure.

In an exemplary embodiment, the alignment tube 110 can comprise a through hole 112, and similarly the alignment ball 130 can include through hole 114 formed therein, as further described in FIG. 3. The aligning assembly is supported by the support assembly. In another embodiment, the alignment tube 110 can be solid, with no through hole section.

The support assembly comprises a base 150, which can optionally include a recess. A plurality of support bearings 140 are positioned on the base 150, optionally in the recess. The support bearings, in an exemplary embodiment, can be roller bearings that are cylindrical in shape and are arranged in parallel with one another. The alignment ball 130 is positioned to rest upon the support bearings. Thus, as shown in FIG. 1, the flange 120 can be supported on the base 150 by the alignment tube 110 coupled to the alignment ball 130. In an exemplary embodiment, the alignment tube 110 is securely located into the ball 130 (e.g., is secured using a fixative such as an epoxy cement, or other means), while the thread 115 of the alignment tube 110 is free to rotate relative to threads of the threaded aperture 125 of the flange 120. It is to be appreciated that while the alignment tube 110 and the alignment ball 130 are illustrated in FIGS. 1 and 2 as two separate components, a kinematic assembly described herein is not so limited, and the tube 110 and the alignment ball 130 can be formed of a single piece.

In an exemplary embodiment, the alignment ball 130 can remain located on bearings 140 by means of gravity acting vertically in direction X on the mass of the kinematic assembly 100, where in effect the mass of the kinematic assembly 100=the mass of the flange 120 (plus any plate, support, device connected thereto)+the mass of the alignment tube 110+the mass of the alignment ball 130.

As depicted in FIG. 1, in an exemplary embodiment, the gravitational force acting on the kinematic assembly 100 can be further supplemented. For example, a magnet 160 can be incorporated into the base 150, which can exert a further downward force on the kinematic assembly 100, where the alignment ball 130 can comprise a magnetic material such as iron, steel, or the like.

To facilitate a change in position of the flange 120 on alignment tube 110, and accordingly the position of the flange 120 with respect to the base 150 (as indicated by the line H of FIG. 1), a hexagonal head 116 can be located on the distal end of the alignment tube 110 and can be turned (where the alignment ball 130 is located at the proximal end of the tube 110), thus causing the alignment tube 110 to rotate. Therefore, as the thread 115 running the length of alignment tube 110 mates with the threaded aperture 125 of the flange 120, when the hexagonal head 116 of the tube 110 is rotated, the thread 115 is rotated. Since the flange 120 is unable to rotate, displacement of thread of the threaded aperture 125 of the flange 120 is effected by rotation of the thread 115, which in turn causes the height H of the flange 120 relative to the position of the base 150 to change. Thus, an according clockwise rotation or anti-clockwise rotation of the hexagonal head 116 (and thus the alignment tube 110) causes a corresponding raising or lowering of the flange 120 (e.g., based upon the handedness of the respective threads). As the assembly 100 is adjusted, it may undergo tilting through a desired angle, as indicated by −XX to +XX. Such tilting can be accommodated through free coupling of the alignment ball 130 with the bearings 140. In an exemplary embodiment, the alignment tube 110 may tilt in a vertical direction +/−10 degrees.

It is to be appreciated that while FIGS. 1-6 illustrate the hexagonal head 116 being located at the distal end of the tube, the kinematic assembly 100 is not so limited. For instance, a drive surface (e.g., comparable to the hexagonal head 116) can be located along any portion of alignment tube 110 to facilitate rotation of the alignment tube 110 to a particular position. Exemplary drive surfaces and internal drive structures that can be used instead of the hexagonal head 116 include a hexagonal socket (e.g., allen or hex type), hex-head, screw drive, TORX, slot head, crosshead, Phillips head, Frearson, Mortorq, Pozidriv, Supadriv, Robertson, Hexalobular, TTAP, hex socket, Bristol, double hex, pentalobe, spline, Torq-set, TA, triple square, etc.

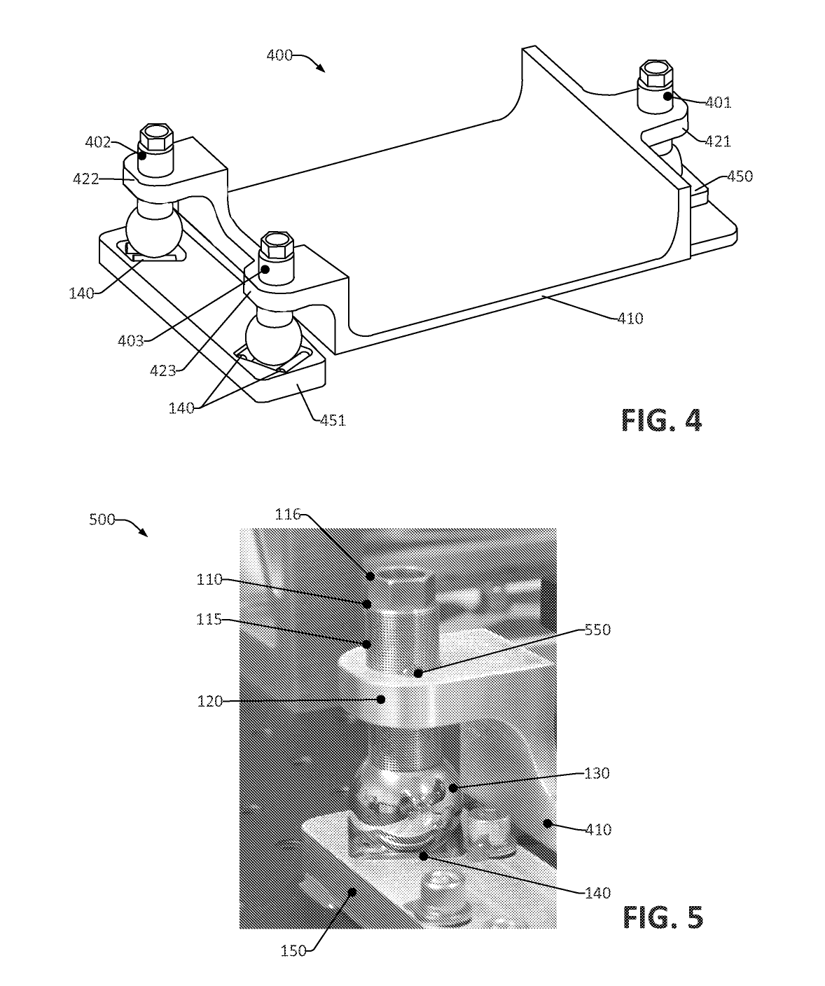

Turning to FIG. 4, a perspective view of an exemplary kinematic mount 400 is illustrated. The kinematic mount 400 comprises three kinematic assemblies 401, 402, and 403 (each comparable to the kinematic assembly 100). The kinematic mount 400 further comprises a support 410, where the kinematic assemblies 401, 402, and 403 are utilized to control the height of the support 410 relative to one or more bases. The support 410 is connected to the respective kinematic assemblies 401, 402, and 403 by respective flanges 421, 422, and 423. As one of the kinematic assemblies (e.g., assembly 401) is adjusted, the remaining unadjusted kinematic assemblies (e.g., kinematic assemblies 402 and 403) are able to compensate for any adjustment in their respective vertical alignments, as their respective alignment balls 130 can tilt on bearings 140 located on bases 450 and 451. For example, if the support 410 is desirably aligned by raising the flange 421 connected to the assembly 401 relative to the base 450, a corresponding adjustment in the alignment of assemblies 402 and 403 may occur (e.g., assemblies 402 and 403 may become titled from an original position). Therefore, as the alignment ball 130 is free to move on bearings 140 of the respective assemblies 402 and 403, while the support 410 is being raised by the assembly 401, compensatory tilting of assemblies 402 and 403 can be accommodated. Adjustment of the position of any of assemblies 401, 402 and 403 can be undertaken in isolation (e.g., individually) or in unison.

FIG. 3 is a cross-sectional view of another exemplary kinematic assembly 300. The kinematic assembly 300 is particularly well-suited for securing portions of a system that includes optical and/or optomechanical devices when moving such system from a first location to a second location. In another exemplary application, the kinematic assembly 300 can be employed when it is to remain in a stable position for an extended period of time. In addition to the various structures illustrated in FIGS. 1 and 2, the assembly 300 further comprises a threaded fastener 310, such as a locking bolt, and a pair of spherical washers (an upper washer 320 and a lower washer 330). In such exemplary embodiment, the alignment ball includes the through hole 114, and the base 150 includes a threaded aperture 350 located between the support bearings 140.

The fastener 310 can be secured (e.g., through use of an allen key or similar device) into the threaded aperture 350 of the base 150, thereby securing the alignment tube 110, the alignment ball 130, and the flange 120. As illustrated, the diameter of the through hole 114 of the alignment ball 130 can be less than the diameter of the through hole 112 of the alignment tube 110, thereby forming, at the junction of the through hole 112 and the through hole 114, a step S against which the lower washer 330 can be located. Hence, when the fastener 310 is tightened onto the base 150 via the threaded aperture 350, a locking force is applied from the fastener 310 to the alignment ball 130 via the spherical washers 320 and 330. Similarly, to unlock the alignment tube 110 and the alignment ball 130 from the base 150, the fastener 310 can be loosened in the threaded aperture 350, thereby releasing the locking force on the spherical washers 320 and 330 and enabling movement of the alignment tube 110 and the alignment ball 130. If required, e.g., during operation of the kinematic assembly 300 (or assemblies 100 as shown in FIG. 4), the fastener 310 and spherical washers 320 and 330 can be removed.

With knowledge of various parameters relating to the respective threads of the alignment tube and threads of the threaded aperture 125 of the flange 120, positioning of the flange 120 can be closely controlled, where such parameters include the thread pitch, thread diameter (major, minor, pitch), etc. Further, with such knowledge, it is possible to determine an angle of revolution of the alignment tube 110 and a corresponding change in height H of the flange 120. For example, where a combination of thread pitch and thread diameter is configured such that a 1° of rotation of the alignment tube 110 results in a corresponding change of 0.001″ (or mil) in position of the height of the flange 120, if the flange 120 is to be moved 0.01″ (or 10 mils), the alignment tube 110 can be turned through 10° in the required direction to facilitate the adjustment resolution.

Further, as illustrated in FIG. 3, individual magnets 360 can be located under the bearings 140, where the magnets 360 can be suitably placed separate magnets or a single disc magnet such as a flattened torus configuration.

FIG. 5 is a photograph illustrating an exemplary kinematic assembly 500. As illustrated, in conjunction with FIGS. 1 and 2, the kinematic assembly 500 comprises the alignment tube 110 having the thread 115 on the exterior thereof, as well as the hexagonal head 116. The alignment tube 110 is attached to the alignment ball 130, which is situated on the bearing(s) 140 located in a recess of the base 150. The flange 120 is threadedly mated with the alignment tube 110, such that as the alignment tube 110 is rotated, the height of the flange 120 is adjusted. As further illustrated in FIG. 5, once the flange 120 (and associated support 410) is deemed to be at the correct height/position/alignment, the position of the flange 120 can be further secured by placement of a fixative 550, where the fixative 550 can be temporarily or permanently placed.

As previously mentioned, the exemplary assemblies 100 and/or 300 can be utilized to facilitate alignment of a portion of an optical system, a portion of an optomechanical system, or other system where one or more portions thereof may require adjustment of any of height, position, alignment, angle, etc. In an exemplary embodiment, rotational positional adjustment of the alignment tube 110 can be effected by applying torsion to the hexagonal head 116, e.g., by a wrench, or similar device, which accordingly provides a positional change of the flange 120. For example, the rotational position of the alignment tube 110 can be performed manually, whereby the position of the alignment tube 110 is changed to facilitate placement of the flange 120 at a desired location.

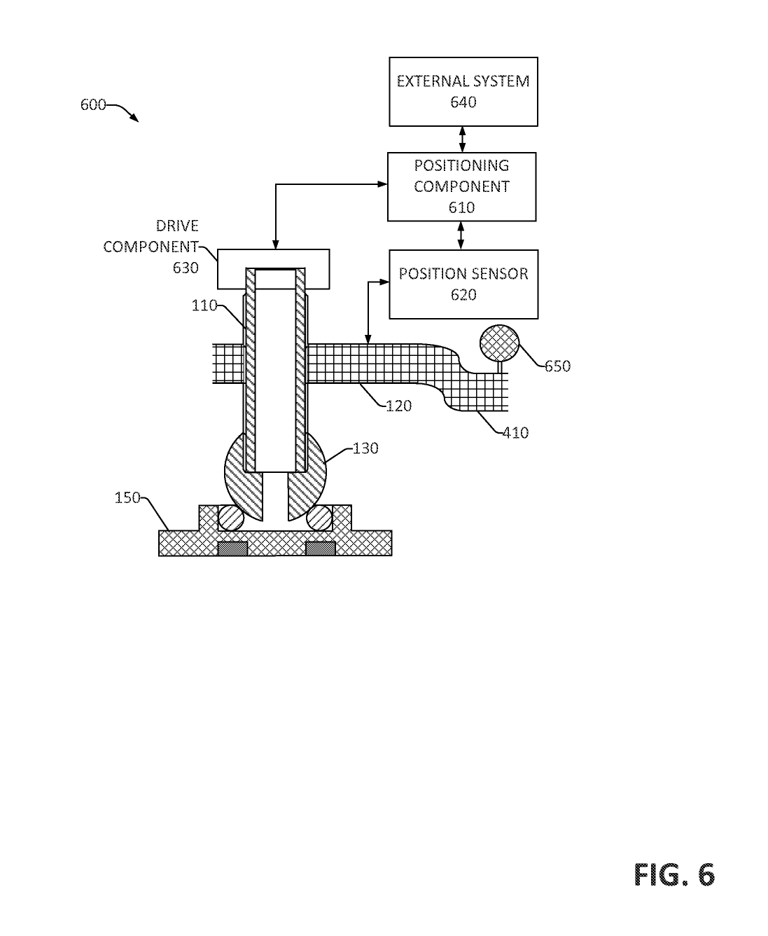

In another exemplary embodiment, the position of the alignment tube 110 and corresponding placement of the flange 120 (and accordingly the support 410) can be controlled by a computer-implemented system. FIG. 6 illustrates a computer-implemented system 600 comprising a positioning component 610 operating in conjunction with a position sensor 620 and a drive component 630. Further, instructions/feedback can be provided to the positioning component 610 from an external system 640.

In an exemplary embodiment, the position sensor 620 can monitor the position of the flange 120 and/or the support 410, or a device 650 (e.g., an optical device) located thereon. Based on feedback received from the position sensor 620, the positioning component 610 can cause the drive component 630 to operate to change the rotational position of alignment tube 110, which, as previously described, effects a corresponding change in the position of the flange 120. The rotational position of the alignment tube 110 can be adjusted, until the position of the flange 120 (and/or the support 410 or the device 650) is determined by the positioning component 610 in conjunction with the position sensor 620 to be at the desired position. The drive component 630 can comprise suitable means to facilitate adjustment of the alignment tube 110, where such means can include a servo-motor, screw drive, and the like.

In a further exemplary embodiment, an external system 640 can provide instruction/feedback to the positioning component 610. For example, in the optical system mentioned herein, a beam of electromagnetic radiation can be directed through the optical system, whereby the device 650 may require a positional adjustment to effect a desired effect in the electromagnetic radiation, e.g., redirection of the beam, splitting of the beam, etc. The position to facilitate the desired effect is identified/determined by the external system 640. For example, a magnitude of beam splitting of the electromagnetic radiation may be increased and/or reduced by orientating the device 650 to a different position. The external system 640 can receive information regarding the magnitude of beam splitting and instruct the positioning component 610 to control operation of the drive component 630 to facilitate reducing or increasing the degree of beam splitting.

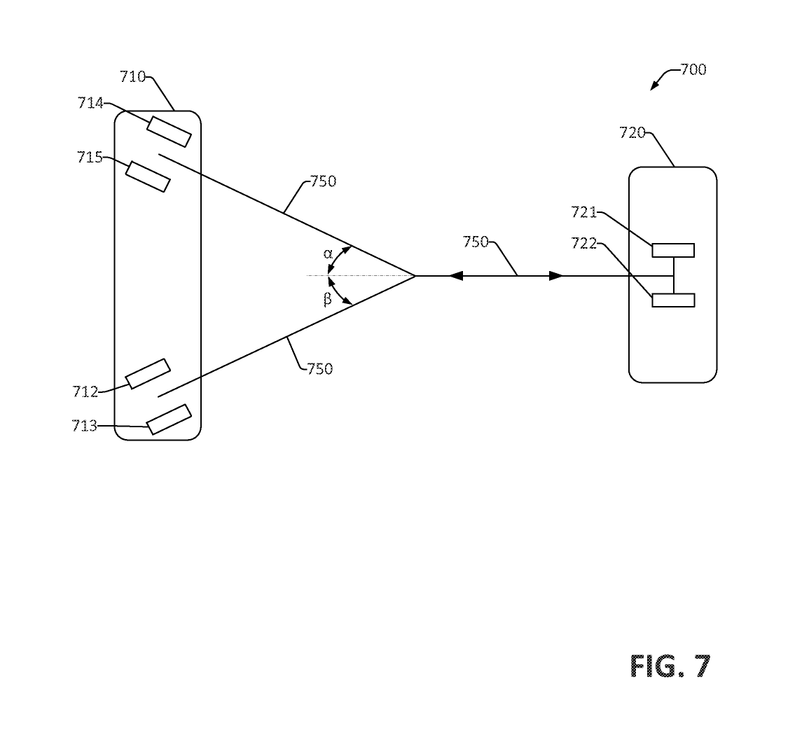

Due at least partially to the essentially loose/free coupling between the alignment assembly components, e.g., the alignment tube 110 and the alignment ball 130 in conjunction with the flange 120 (and the support 410) and the supporting bearings 140, a degree of change in the relative position of the one or more assemblies 401-403 can be accommodated. FIG. 7 illustrates an assembly 700 configured to compensate for expansion of an alignment system, according to an exemplary embodiment. The assembly 700 comprises of a pair of base plates 710 and 720, where, respectively located thereon are three pairs of bearings: bearings 712 and 713; bearings 714 and 715; and bearings 721 and 722. The base plates 710 and 720 provide the same functionality as the base 150, and the bearings 712 and 713, the bearings 714 and 715, and the bearings 721 and 722 are respectively comparable to the bearings 140. In an exemplary embodiment, a device (e.g., the device 650) located on a support structure (e.g., the support 410) during operation (e.g., processing of an electromagnetic beam) may undergo a degree of heating, which can lead to thermal expansion of any of the support 410, the flanges 120, the alignment tube 110, the alignment ball 130, etc.

In a conventional system, where various components providing positional adjustment are in a fixed location relative to each other, thermal expansion (e.g., of a supporting plate) can be problematic and difficult to accommodate. However, the assembly 700 can accommodate such thermal expansion. As illustrated, the bearings 712-713, the bearings 714-15, and the bearings 721-722 can be roller-type bearings, and thus can be aligned along their respective lengths to accommodate thermal expansion (e.g., of the support 410) whereby, owing to each of the alignment balls 130 being in free contact with the respective bearing pairs 712-713, 714-15, and 721-722, any of the alignment balls 130 can slide along their respective roller bearing pair while maintaining their associated flanges 120 at a desired height. As illustrated in FIG. 7, bearing pairs 712-713 and 714-715 can be aligned at an angle (respectively a and (3) to the bearing pair 721-722, enabling thermal expansion along a desired direction of a thermal growth path 750. In an exemplary embodiment, alignment of the respective bearings can be parallel to a determined direction of thermal expansion. In another embodiment, a structure (e.g., the support 410) can be configured such that thermal expansion only occurs in a single direction and thus a single roller pairing (e.g., the bearings 721-722) may be utilized to accommodate for the thermal expansion of the structure in the single direction. With such an embodiment, a single aligning assembly (e.g., the alignment tube 110 and the alignment ball 130) may be attached to the structure to enable motion in the single direction, whereby the aligning assembly is coupled with the single roller bearing pair, and the bearing pairs 712-713 and 714-715 (and associated aligning assemblies) are not included in the apparatus, and the structure is fixed at that end.

The various components comprising assemblies 100-700 can be constructed from any suitable material(s) to facilitate operation of the various embodiments presented herein. For example, any of the various components can be formed with a hardened steel such as alloy 400 series steel, alloy 51200 bearing steel, a ceramic, a polymer, a composite, or any combination thereof. Materials selection can be based on selecting a material that is not prone to surface distortion (e.g., dimpling) when placed under load in contact with another material, e.g., the alignment ball 130 should not undergo dimpling when placed on the bearing(s) 140.

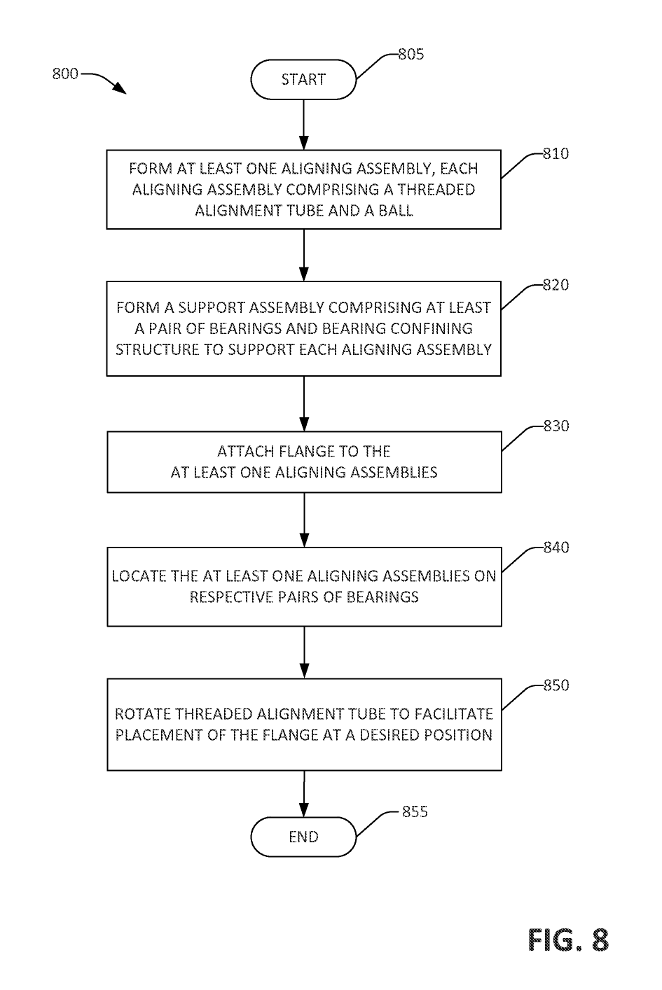

FIGS. 8-11 illustrate exemplary methodologies relating to positioning of a component. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement the methodologies described herein.

FIG. 8 illustrates an exemplary methodology 800 for constructing and operating a kinematic assembly to facilitate positioning of a device, for example in an optical system. The methodology 800 starts at 805, and at 810, at least one aligning assembly is formed. As previously mentioned, any number of kinematic assemblies can be utilized to facilitate positioning of the device. For instance, three kinematic assemblies can be utilized to effect a tripod arrangement providing stability against downward forces, horizontal forces and movements about a horizontal axis. As previously described, each aligning assembly can comprise an alignment tube having a threaded exterior, whereby an alignment ball is mechanically attached (e.g., threaded onto the alignment tube).

At 820, for each aligning assembly, a support assembly can be formed to facilitate supporting the aligning assembly. A support assembly can comprise of a base into which are located a pair of bearings.

At 830, a flange comprising a threaded aperture is attached onto the alignment tube, wherein the threaded aperture has a diameter and thread pitch to fit the diameter and thread pitch of the alignment tube.

At 840, each alignment assembly can be located on its respective support assembly, e.g., the alignment ball for each alignment assembly is located on its respective support bearings.

At 850, with each alignment assembly positioned on its respective support assembly, the alignment tube can be rotated to facilitate adjustment of the height of the flange respectively attached to the alignment tube. As each alignment tube is rotationally adjusted, the height of the flange can be changed while any according tilt in a support plate associated with the flange is accommodated by an according tilt in the alignment tubes, which are not being rotationally adjusted but are free to be aligned on their respective support bearings. Rotation of the alignment tube can be by any suitable means, e.g., an external-drive structure, an internal-drive structure, or combination thereof. The methodology 800 completes at 855.

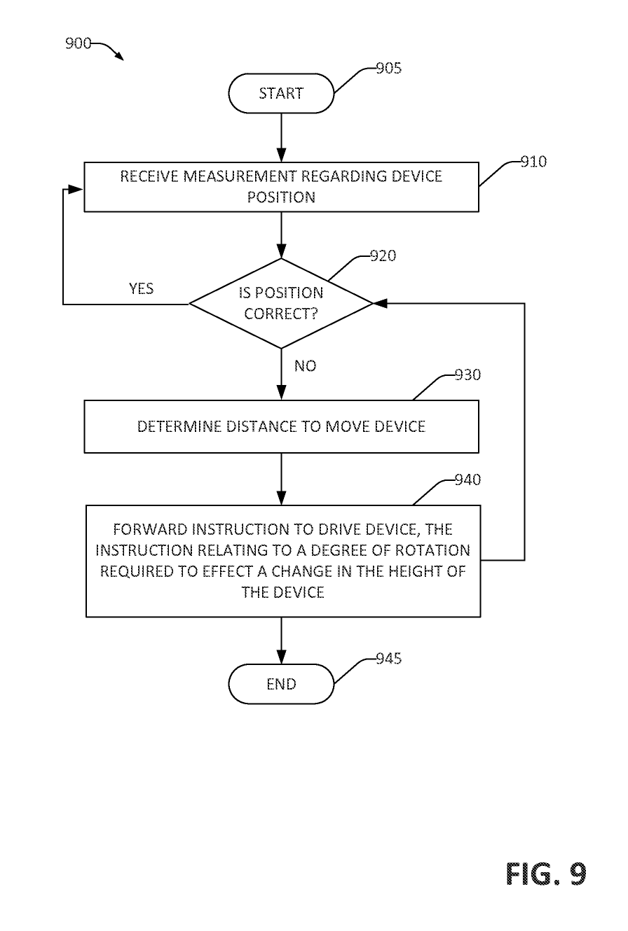

FIG. 9 illustrates an exemplary methodology 900 for adjusting a position of one or more alignment assemblies to facilitate positioning of an associated flange, a support structure, a component, and the like. In an exemplary embodiment, the methodology 900 can be implemented in part by a computer-based system, wherein the computer-based system can comprise any necessary processor(s), memory, executable instructions, etc.

In an embodiment, the methodology 900 starts at 905, and at 910, a measurement is received regarding the current position of a device, for example the position of a lens relative to an optical axis. In an exemplary embodiment, the position of the device can be directly determined, for example, by a position measurement taken directly from a surface of the device, a surface of a plate or similar device supporting the device, position of a flange connecting the supporting plate to an alignment tube comprising the alignment assembly, or the like. In another embodiment, the measurement can be received from an external source. For example, in the previously mentioned optical system, a beam of electromagnetic radiation can be directed through the optical system and is incident on the surface of the device, passes through the device, undergoes beam splitting by the device, a quantity associated with the electromagnetic radiation is determined, etc. Based upon measurements regarding the interaction of the electromagnetic radiation and the device, an initial position of the device relative to the electromagnetic beam can be determined/inferred by an external component.

At 920, a determination can be made regarding the received measurement and a desired position of the device. In the event of the position being determined to be correct, the methodology 900 returns to 910 to await receipt of the next measurement regarding the position of the device.

If it is determined at 920 that the position is incorrect, at 930 a determination can be made regarding a distance to be moved to facilitate the device being placed in the required position. The distance can be of any movement, e.g., a linear displacement, a vertical displacement, a horizontal displacement, a vector displacement, an angular displacement, a rotational displacement, a combination of any of the foregoing, etc.

In an exemplary embodiment, the diameter of the aligning tube, associated thread diameter (any of major diameter, minor diameter, average pitch diameter, pitch diameter), thread pitch, current angle of an aligning tube, position of supporting base, position of a supporting flange, etc., can be known. Based thereon, it is possible to determine an angle of revolution of the aligning tube to facilitate placing the device at the desired position. For example, where a combination of thread pitch and thread diameter is configured such that a 1° of rotation of the aligning tube results in a corresponding change of 0.010″ (or 10 mils) in position of the height of the device, the aligning tube can be turned through 10° to facilitate moving the device 0.1″ (or 100 mils). In an exemplary embodiment, such determination can be performed by a manual operation.

In another embodiment, whereby the computer-based system comprises a processor(s), memory, etc., the determination(s) can be performed by the processor(s) executing instructions relating to adjustment of position of the aligning tube (and corresponding positional change of the device, flange, supporting structure, etc.), wherein the determinations can be performed in conjunction with one or more lookup tables pertaining to such parameters as the diameter of the aligning tube, associated thread diameter (any of major diameter, minor diameter, average pitch diameter, pitch diameter), thread pitch, current angle of an aligning tube, position of supporting component, position of a supporting flange, etc. At 940, an instruction is forwarded to a drive component, wherein the instruction relates to a degree of rotation required to effect a change in the height of the device. Optionally, the methodology 900 can return to 920, where again a determination is made regarding whether the device position is correct. The methodology 900 completes at 945.

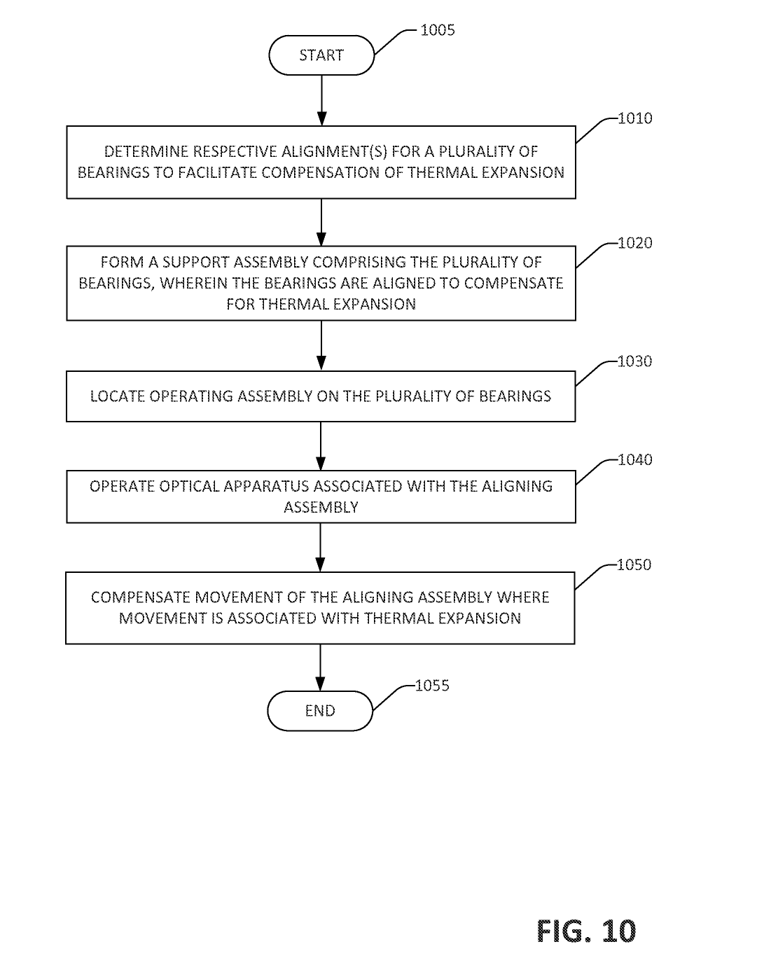

FIG. 10 illustrates an exemplary methodology 1000 for compensating for thermal expansion of one or more structures associated with an assembly, such as an optical apparatus. As previously mentioned, during operation of the optical apparatus, thermal expansion of one or more structures included in the apparatus can occur. For example, a structure may undergo heating during operation of the apparatus, where the thermal energy can be transferred to a structure supporting the heated component resulting in thermal expansion of the supporting structure. With regard to the various embodiments presented herein, support of the apparatus can be provided by one or more bearing pairings, where the various bearings can be of a roller-bearing type.

In another embodiment, the methodology 1000 starts at 1005, and at 1010, a determination can be made regarding aligning a plurality of bearings to facilitate compensation of thermal expansion of the optical apparatus. The determination can be made with regard to various pertinent parameters such as the distance between the respective bearing pairings, an anticipated magnitude of thermal expansion (e.g., based on materials utilized, operating temperatures, change in operating temperatures), or the like.

At 1020, a support assembly can be constructed, wherein the bearings are aligned at the determined angle(s).

At 1030, an operating assembly (e.g., the optical apparatus, aligning assembly, etc.) comprising one or more aligning assemblies can be located onto the support assembly, wherein in an initial condition the various aligning assemblies are located on their respective bearing pairs.

At 1040, operation of the optical apparatus is undertaken, whereby during the operation, a device (e.g., such as a beam splitter, a gas cell, a lens, a mirror, etc.) may undergo heating which can give rise to thermal expansion of the component, or associated component (e.g., a support assembly).

At 1050, based upon the free coupling between an aligning assembly and its associated bearing pair, the aligning assembly (e.g., the ball comprising the aligning assembly) is free to move along the associated bearing pair and thus the thermal expansion resulting from operation of the optical apparatus can be accommodated by the combination of the aligning assembly and associated pair of bearings. The methodology 1000 completes at 1055.

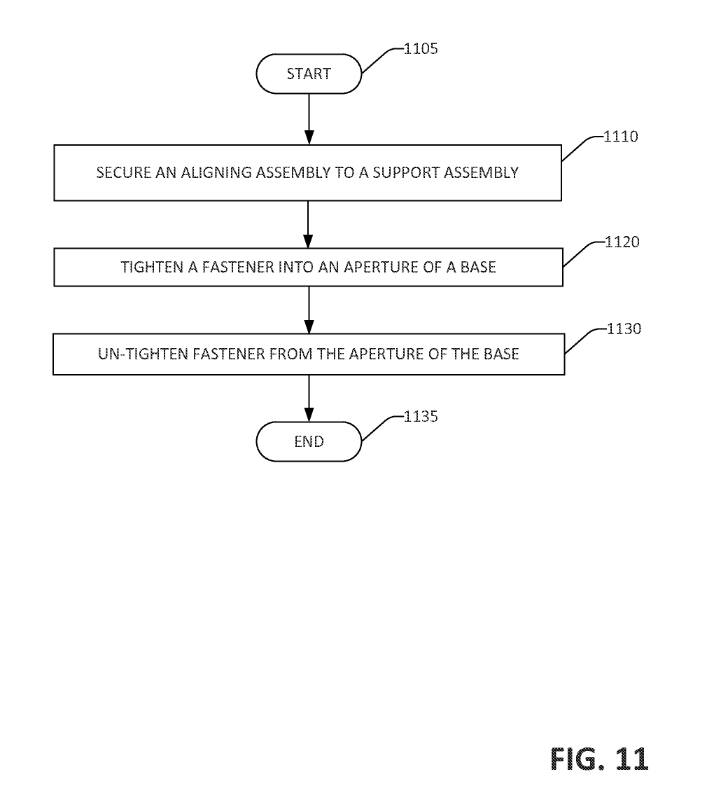

FIG. 11 illustrates an exemplary methodology 1100 for securing of a kinematic assembly. The methodology 1100 starts at 1105, and at 1110, a securing apparatus, such as a fastener and spherical washers, can be utilized to secure an aligning assembly (e.g., comprising an aligning tube and aligning ball) to a support assembly (e.g., comprising a base and bearings). A hole can be bored into the aligning ball, where the bored hole has a smaller diameter than a through hole running along the internal length of the aligning tube. A fastener, e.g., a bolt, can be positioned through the spherical washers and located in an aperture, e.g., threaded, in the base, wherein the aperture in the base is located between two or more bearings that support the aligning ball.

At 1120, the fastener can be tightened into the aperture in the base, thereby causing the spherical washers to be pressed against the stepped structure, and thus causing the aligning ball (and accordingly the aligning tube and any connected structure such as a supporting plate) to become locked in place against the two or more bearings. The aligning tube does not have to be aligned perpendicular to the base, thereby enabling a tilted aligning tube (e.g., titled as a result of aligning a supporting plate and/or an associated component) to be secured without loss of the angle of tilt.

At 1130, a previously tightened fastener can be un-tightened in the aperture in the base, thereby causing the spherical washers to be loosened against the stepped structure, and thus causing the aligning ball (and accordingly the aligning tube and any connected structure such as a supporting plate) to become unlocked against the two or more bearings. By unlocking the fastener (which, along with the spherical washers can be subsequently removed), the aligning assembly (e.g., comprising the aligning tube and aligning ball) is free to move to facilitate subsequent adjustment of a component in an optical system as previously described. The methodology 1100 completes at 1135.

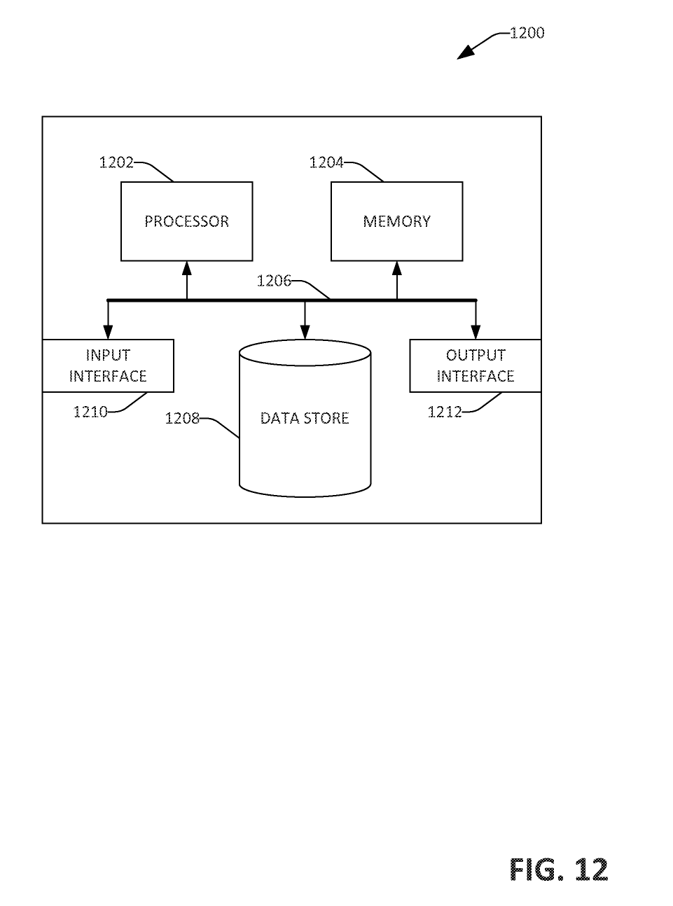

Referring now to FIG. 12, a high-level illustration of an exemplary computing device 1200 that can be used in accordance with the systems and methodologies disclosed herein is illustrated. For instance, the computing device 1200 may be used in a system to position a device, e.g., in an optical apparatus, an optomechanical apparatus, or any other apparatus having one or more devices requiring controlled positioning. The computing device 1200 includes at least one processor 1202 that executes instructions that are stored in a memory 1204. The instructions may be, for instance, instructions for implementing functionality described as being carried out by one or more components discussed above or instructions for implementing one or more of the methods described above. The processor 1202 may access the memory 1204 by way of a system bus 1206. In addition to storing executable instructions, the memory 1204 may also store operating parameters, required operating parameters, and so forth.

The computing device 1200 additionally includes a data store 1208 that is accessible by the processor 1202 by way of the system bus 1206. The data store 1208 may include executable instructions, operating parameters, required operating parameters, etc. The computing device 1200 also includes an input interface 1210 that allows external devices to communicate with the computing device 1200. For instance, the input interface 810 may be used to receive instructions from an external computer device, from a user, etc. The computing device 1200 also includes an output interface 1212 that interfaces the computing device 1200 with one or more external devices. For example, the computing device 1200 may display text, images, etc. by way of the output interface 1212.

Additionally, while illustrated as a single system, it is to be understood that the computing device 1200 may be a distributed system. Thus, for instance, several devices may be in communication by way of a network connection and may collectively perform tasks described as being performed by the computing device 1200.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What has been described above includes examples of one or more embodiments. It is, of course, not possible to describe every conceivable modification and alteration of the above structures or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A kinematic assembly comprising:
a first assembly comprising:
an alignment tube having a threaded external surface, a proximal end, and a distal end, and
an alignment ball having a threaded aperture, wherein the alignment ball is coupled to the alignment tube by way of threads of the proximal end mating with threads of the threaded aperture of the alignment ball; and
a second assembly comprising:
a base and
a pair of bearings located on the base, wherein the alignment ball is positioned on the pair of bearings.

2. The kinematic assembly of claim 1, wherein a first thread pitch of the threaded external surface of the alignment tube is equivalent to a second thread pitch of an aperture in a support plate, wherein a diameter of the alignment tube and the aperture are machined to facilitate coupling of the alignment tube to the support plate, and wherein the coupling is by threading the alignment tube onto the support plate.

3. The kinematic assembly of claim 2, wherein the alignment tube comprises a drive surface located on the distal end thereof.

4. The kinematic assembly of claim 3, wherein torsion applied to the drive surface effects rotation of the alignment tube, and the rotation of the alignment tube effects a change in the position of the support plate along the threaded external surface of the alignment tube.

5. The kinematic assembly of claim 1, wherein the alignment ball includes a through hole, wherein the alignment tube includes a through hole, and wherein the through hole of the alignment ball is aligned with the through hole of the alignment tube.

6. The kinematic assembly of claim 5, wherein the through hole of the alignment ball has a smaller diameter than the through hole of the alignment tube such that a stepped structure is formed at a junction of the through hole of the alignment tube and the through hole of the alignment ball.

7. The kinematic assembly of claim 6, wherein the base further comprises a threaded aperture, the threaded aperture of the base being positioned between bearings in the pair of bearings.

8. The kinematic assembly of claim 7, further comprising a fastener, a first spherical washer, and a second spherical washer, wherein the first spherical washer and the second spherical washer form a pair, the first spherical washer being located on the fastener and further located on the stepped structure, the second spherical washer being located on the fastener between the first spherical washer and a flanged head of the fastener, and wherein a threaded end of the fastener is located in the threaded aperture in the base.

9. The kinematic assembly of claim 8, wherein tightening of the fastener in the threaded aperture in the base effects application of a force on the first spherical washer and the second spherical washer, which applies a locking force to the alignment ball against the pair of bearings to facilitate securing the alignment ball and the alignment tube in a fixed position.

10. The kinematic assembly of claim 1, further comprising a magnet located in the base, wherein the magnet effects a magnetic force on the alignment ball and the magnetic force supplements a gravitational force effected by a mass of at least the alignment tube and the alignment ball.

11. The kinematic assembly of claim 1, wherein the pair of bearings are roller bearings.

12. The kinematic assembly of claim 11, wherein the pair of roller bearings is aligned to facilitate accommodation of expansion of a device attached to the alignment tube.

13. The kinematic assembly of claim 1, wherein the alignment ball and the alignment tube are formed of ferrous material.

14. The kinematic assembly of claim 1, wherein the pair of bearings comprises cylindrical roller bearings arranged in parallel with one another.

15. A method for positioning a device, the method comprising:
forming a first assembly by attaching a tube having a threaded external surface to a ball having a threaded aperture, wherein a distal end of the tube is attached to the ball by threading the tube into the threaded aperture;
locating a pair of bearings on a base; and
positioning the ball onto the pair of bearings.

16. The method of claim 15, further comprising:
attaching a support plate to the tube, wherein the support plate comprises a threaded aperture having a same thread pitch and diameter as the threaded external surface of the tube, and the attaching being by threading the tube onto the support plate.

17. The method of claim 16, further comprising adjusting a position of the support plate relative to a position the base by rotating the tube, thereby causing the support plate to move along the threaded external surface of the tube.

18. A kinematic assembly comprising:
an alignment tube having a first diameter, a threaded external surface, a proximal end, and a distal end, the distal end having a hexagonal head; and
an alignment ball having a threaded aperture, the threaded aperture comprising a second diameter that conforms to the first diameter of the alignment tube, the alignment ball secured to the alignment tube by way of the threaded external surface at the proximal end of the alignment tube mating with the threaded aperture of the alignment ball.

19. The kinematic assembly of claim 18, further comprising:
a base comprising a recess;
a first roller bearing positioned in the recess of the base; and
a second roller bearing positioned in the recess of the base, the first roller bearing and the second roller bearing being parallel to one another and separated by a gap, wherein the alignment ball is positioned to rest upon the first roller bearing and the second roller bearing.

20. The kinematic assembly of claim 19, wherein the alignment tube, the alignment ball, the first roller bearing, and the second roller bearing are composed of a magnetic material.
